(19) United States
(12) Patent Application Publication
(10) Pub. No.: US 2020/0159229 A1
(43) Pub. Date: May 21, 2020

(54) SYSTEM AND METHOD FOR CREATING A SINGLE PERSPECTIVE SYNTHESIZED IMAGE

(71) Applicant: R-Go Robotics LTD., Caesarea (IL)

(72) Inventors: Nizan HORESH, Caesarea (IL); Amir BOUSANI, Kadima (IL)

(73) Assignee: R-Go Robotics LTD., Caesarea (IL)

(21) Appl. No.: 16/750,703

(22) Filed: Jan. 23, 2020

Related U.S. Application Data
(63) Continuation of application No. PCT/US2019/046260, filed on Aug. 13, 2019.
(60) Provisional application No. 62/718,188, filed on Aug. 13, 2018.

(51) Int. Cl. G05D 1/02; H04N 13/189; A01D 34/00

(52) U.S. Cl. CPC G05D 1/0212; H04N 13/189; A01D 2101/00; G05D 2201/0208; A01D 34/008

(57) ABSTRACT

Techniques for controlling a robotic device in motion using image synthesis are presented. A method includes determining local motion features based on image patches included in first and second input images captured by a camera installed on the robotic device; determining a camera motion based on the local motion features, wherein the camera motion indicates a movement of the camera between capture of the first input image and capture of the second input image; determining a scene geometry based on the camera motion, wherein the scene geometry is a set of three-dimensional coordinates corresponding to two-dimensional image coordinates of the image patches; generating a single perspective synthesized image based on the camera motion and the scene geometry; detecting a change between the first and second input images based on the synthesized image; and modifying motion of the robotic device based on the detected at least one change.

### CROSS-REFERENCE TO RELATED APPLICATIONS

This application is a continuation of International Patent Application No. PCT/US2019/046260 filed on Aug. 13, 2019, now pending, which claims the benefit of U.S. Provisional Application No. 62/718,188 filed on Aug. 13, 2018, the contents of which are hereby incorporated by reference.

### TECHNICAL FIELD

The present disclosure relates generally to image capture, and more specifically to creating single perspective images based on images captured at different perspectives.

### BACKGROUND

The robotics market has boomed since around 2016, resulting in projections of billions of robots to be created in the following years. The use of robots has expanded in many areas such as consumer, commercial, and industrial applications.

To aid in various functions, robots are often equipped with sensors for detecting features in their environments. Some of these sensors may aid in spatial awareness for the robot. For example, a camera may be used for visual recognition of objects in the surrounding environment. Providing spatial awareness using these sensors requires complex machine vision systems. Existing robots utilizing these complex machine vision systems often face challenges in accurately detecting obstacles and other objects. Also, there are no off-the-shelf solutions and, therefore, incorporating these machine vision systems into existing robots often requires significant manual adaptation. These and other challenges distract from other problems faced by robotics developers, thereby hindering progress.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for controlling a robotic device in motion using image synthesis. The method comprises: determining a plurality of local motion features based on a plurality of image patches included in a plurality of input images captured by a camera installed on the robotic device, the plurality of input images including a first input image and a second input image; determining a camera motion based on the plurality of local motion features, wherein the camera motion indicates a movement of the camera between capture of the first input image and capture of the second input image; determining a scene geometry based on the camera motion, wherein the scene geometry is a set of three-dimensional coordinates corresponding to two-dimensional image coordinates of the plurality of image patches; generating a synthesized image based on the camera motion and the scene geometry, wherein the synthesized image is a single perspective image; detecting at least one change between the first input image and the second input image based on the synthesized image; and modifying movement of the robotic device based on the detected at least one change.

Certain embodiments disclosed herein also include a non-transitory computer readable medium having stored thereon causing a processing circuitry to execute a process, the process comprising: determining a plurality of local motion features based on a plurality of image patches included in a plurality of input images captured by a camera installed on the robotic device, the plurality of input images including a first input image and a second input image; determining a camera motion based on the plurality of local motion features, wherein the camera motion indicates a movement of the camera between capture of the first input image and capture of the second input image; determining a scene geometry based on the camera motion, wherein the scene geometry is a set of three-dimensional coordinates corresponding to two-dimensional image coordinates of the plurality of image patches; generating a synthesized image based on the camera motion and the scene geometry, wherein the synthesized image is a single perspective image; detecting at least one change between the first input image and the second input image based on the synthesized image; and modifying movement of the robotic device based on the detected at least one change.

Certain embodiments disclosed herein also include a system for controlling a robotic device in motion using image synthesis. The system comprises: a processing circuitry; and a memory, the memory containing instructions that, when executed by the processing circuitry, configure the system to: determine a plurality of local motion features based on a plurality of image patches included in a plurality of input images captured by a camera installed on the robotic device, the plurality of input images including a first input image and a second input image; determine a camera motion based on the plurality of local motion features, wherein the camera motion indicates a movement of the camera between capture of the first input image and capture of the second input image; determine a scene geometry based on the camera motion, wherein the scene geometry is a set of three-dimensional coordinates corresponding to two-dimensional image coordinates of the plurality of image patches; generate a synthesized image based on the camera motion and the scene geometry, wherein the synthesized image is a single perspective image; detect at least one change between the first input image and the second input image based on the synthesized image; and modify movement of the robotic device based on the detected at least one change.

Certain embodiments disclosed herein also include a robotic device. The robotic device comprises: a camera, wherein the camera is configured to capture a plurality of images, the plurality of images including a first image and a second image; a processing circuitry; and a memory, the memory containing instructions that, when executed by the processing circuitry, configure the processing circuitry to control movement of the robotic device based on image synthesis, wherein the processing circuitry is further configured to: determine a plurality of local motion features based on a plurality of image patches included in the plurality of images; determine a camera motion based on the plurality of local motion features, wherein the camera motion indicates a movement of the camera between capture of the first image and capture of the second image; determine a scene geometry based on the camera motion, wherein the scene geometry is a set of three-dimensional coordinates corresponding to two-dimensional image coordinates of the plurality of image patches; generate a synthesized image based on the camera motion and the scene geometry, wherein the synthesized image is a single perspective image; detect at least one change between the first image and the second image based on the synthesized image; and modify movement of the robotic device based on the detected at least one change.

### BRIEF DESCRIPTION OF THE DRAWINGS

The subject matter disclosed herein and other objects, features, and advantages of the disclosed embodiments will be apparent from the following detailed description taken in conjunction with the accompanying drawings.

FIG. 1 is a flowchart illustrating a method for creating a single perspective synthesized image according to an embodiment.

FIG. 2 is a schematic diagram of an image synthesizer according to an embodiment.

FIG. 3 is a schematic diagram of a camera module according to an embodiment.

FIG. 4A shows a stitched image.

FIG. 4B shows a stitched image featuring image patches.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

It has been identified that challenges in object identification may be solved by accurately determining three-dimensional characteristics of the scene, i.e., the environment in which a robot moves and captures images of. Further, it has been identified that it is desirable to allow for such accurate determination of three-dimensional scene characteristics using a single camera that is moved as a robot navigates. Accordingly, the disclosed embodiments provide a method for creating a synthesized image based on images captured by the same camera as the camera moves. The synthesized image may be utilized to, among other things, detecting objects in the environment, detecting anomalies in input images, detect changes among input images, provide a graphical interface through which a user may interact, and the like.

The various disclosed embodiments include a method and system for creating a single perspective synthesized image. The single perspective synthesized image is a projection created based on input images captured by a moving camera. As a non-limiting example, the projection may be an orthographic projection showing, for example, a top or bird's-eye view.

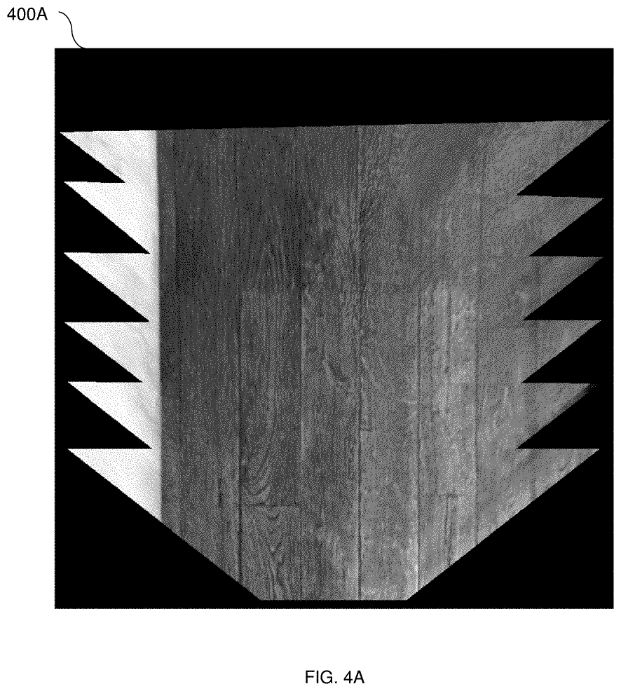

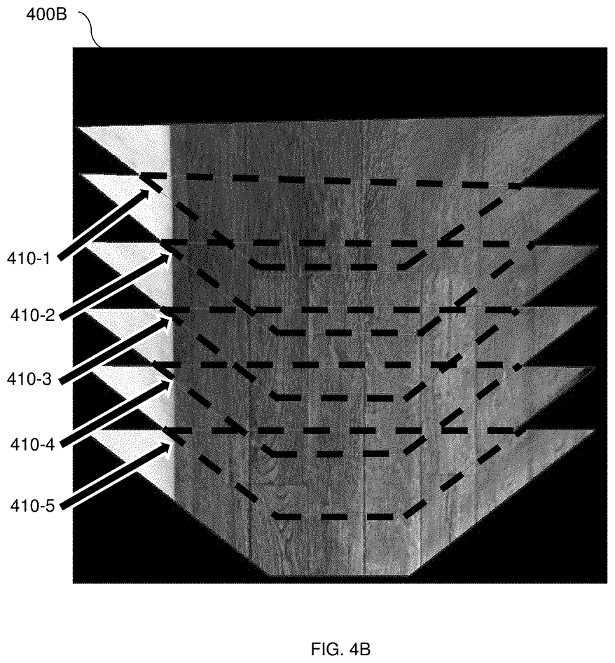

In an embodiment, a single perspective synthesized image is created based on two or more input images. Each input image includes one or more image patches that show sub-regions of the images. Each of the input images is at least partially overlapping with one or more other input images such that the overlapping inputs images show overlapping fields of view. Further, for any two of the input images, there is a sequence of overlapping pairs of input images that ends with one of the other input images. FIG. 4B shows an example of a sequence of overlapping pairs of input images of a synthesized image.

Local motion features of the sub-regions between images are determined. Based on the determined local motion features, a camera motion and scene geometry are determined. A three-dimensional structure is computed based on the at least partially overlapping images. The three-dimensional structure represents a geometry of the environment shown in the images. The single perspective synthesized image is created based on the three-dimensional structure and the input images.

In an embodiment, the single perspective synthesized image is used for one or more robotics applications. Specifically, camera motions are accounted for in creating the synthesized images to allow for accurate image creation even when a robot equipped with the camera is moving.

Further, in some embodiments, changes or anomalies in the synthesized image may be determined and utilized for additional robot functions such as, but not limited to, cleaning (e.g., by identifying changes as objects to be cleaned). The changes may be, but are not limited to, changes between the current synthesized image and a previously generated synthesized image, changes between the synthesized image and a subsequently captured image, and the like.

Additionally, the single perspective synthesized image may be sent for display to a user (e.g., via a user device operated by the user). To this end, a graphical user interface incorporating the single perspective synthesized image may be generated and displayed on the user device. The graphical user interface may allow, for example, the user to control the robot with respect to objects shown in the synthesized image (e.g., by interacting with the objects, the robot may be directed to move toward or away from the objects), the user to mark any portions of the synthesized image (e.g., marking “no-go-boundaries which the robot should be forbidden from moving to), and the like. To this end, any changes or anomalies in the synthesized image may trigger generation of an alert to be sent to the user device.

It is noted that, when using a single camera, both the camera motion and the three-dimensional structure of the scene can only be determined up to a limited scale that does not typically accurately represent the actual sizes of objects shown in images. Thus, determining a scale factor allows for determining actual sizes of objects shown in the input images. As a non-limiting example, the scale factor may be determined such that a size of a portion of the determined three-dimensional structure matches a predetermined actual size of an object in the portion.

In some embodiments, a scale factor may be determined based on one or more parameters such as, but not limited to, predetermined scene geometry, motion of a locomotive system used to move the camera (e.g., motion of wheels of a robot), acceleration measured by an accelerometer, a configuration of a stereo camera (when the camera used for capturing the input images is a stereo camera), and the like. Thus, the scale factor may be determined at least partially based on movements of a robot. In an example implementation, the scale factor may be utilized when the input images are captured by a single camera.

The disclosed embodiments aid in providing improved spatial cognition for robotics applications. The disclosed embodiments are flexible and scalable as compared to existing solutions. Various disclosed embodiments may aid specifically in basic mapping and navigation, thorough free-space analysis, obstacle detection, object recognition, scene understanding, and spatial contextual awareness. Additionally, the disclosed embodiments may be performed using a single, low-quality camera rather than requiring multiple high-end cameras while maintaining accuracy.

The disclosed embodiments may be utilized in robotics applications and, in particular, in navigation of a robot moving in a three-dimensional environment. Specifically, the scene geometry and synthesized image may be utilized to track the position of a robot in the three-dimensional environment, to generate maps of the environment, and to determine a position of the robot within each map. The relative positions of the robot may be used for the navigation by, for example, selecting a path on the map from the current location to a desired new position. The flexibility and lower camera quality requirements of the existing solutions may allow for creating synthesized images using a wider variety of robotics and, in particular, smaller robots or robots featuring less powerful hardware, than that of existing solutions.

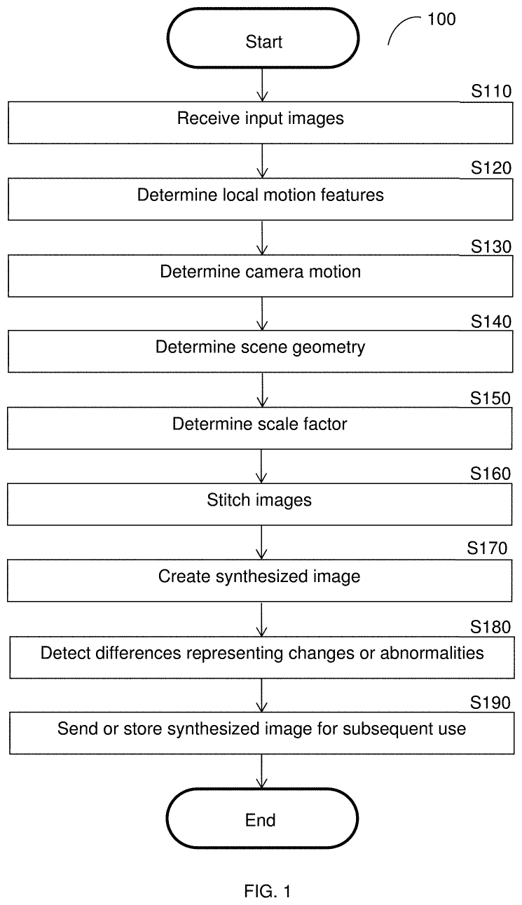

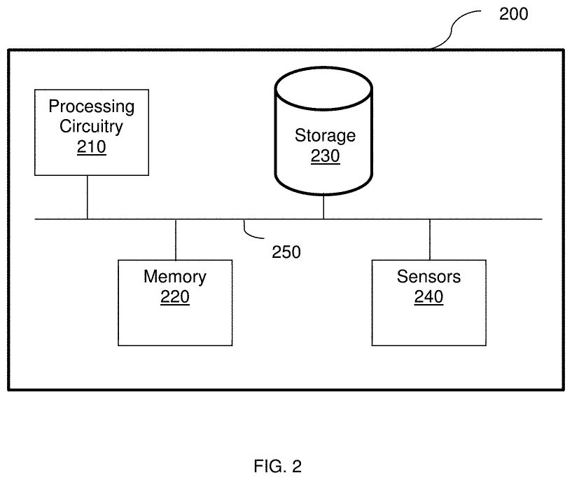

FIG. 1 shows an example flowchart illustrating a method for creating a single perspective synthesized image according to an embodiment. In an embodiment, the method may be performed by the image synthesizer 200, FIG. 2.

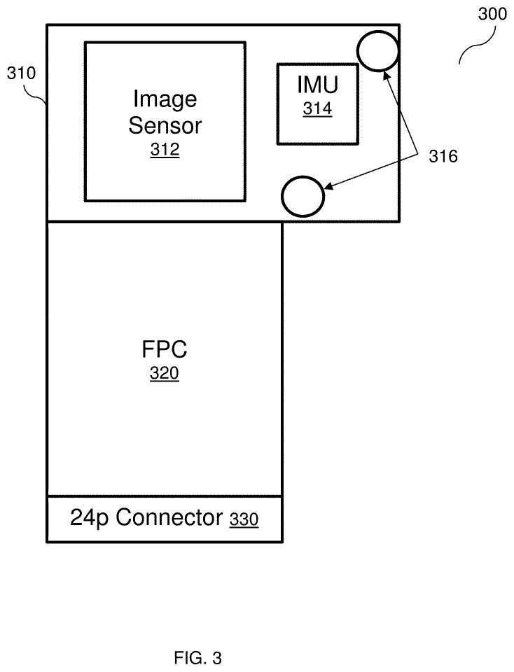

At S110, input images are received. The input images each include one or more image patches showing sub-regions of the input images. The input images are at least partially overlapping such that at least some of the input images show portions of the same sub-regions. The images are captured, by one or more image sensors, in an environment and collectively show a scene within the environment. The image sensors may be disposed on a robot configured for movement and, in particular, may be disposed such that the image sensors are positioned to capture appropriate images. An example setup of a camera module including an image sensor is described further herein below with respect to FIG. 3. The environment is a real or virtual location such that the scene is a visual representation of one or more portions of the environment.

At S120, a local motion is determined for each image patch. The local motion is in the form of local motion features describing the transformation from the image patch to each of one or more other image patches of the other input image. The local motion features may be, for example, motion vectors.

In an embodiment, S120 may include computing a two-dimensional normalized cross correlation (NCC) between a first image patch of a first input image and a second image patch of a second input image. The NCC may be computed for various second images. For example, NCCs may be determined for offsets of the same image patch shown in different input images. The local motion features may be determined by identifying the highest NCC value among the determined NCC values. Alternatively, the local motion features may be determined by estimating optical flow using, for example, the Lucas-Kanade algorithm, or by performing Scale Invariant Feature Transform (SIFT) features matching.

At S130, a camera motion is determined based on the local motion features. The camera motion indicates a change in position, orientation, or both, of the camera used to capture the input images between capturing of the respective input images. The camera motion may include translation and rotation.

In an embodiment, the camera motion is determined based on the local motion features and indicates relative positions of the camera with respect to the scene geometry when the respective input images were captured. The camera motion may be further determined based on one or more predetermined camera intrinsic calibration parameters. The camera motion may be determined using the Eight-point algorithm. Alternatively, the camera motion and scene geometry may be determined using, for example, bundle adjustment.

In an embodiment, the camera motion may be determined based on only a portion of the local motion features. Specifically, outlier local motion features may be excluded. The outlier local motion features may be determined using a statistical model such as, but not limited to, random sampling consensus (RANSAC). Excluding outlier local motion features provides more accurate camera motions and, therefore, scene geometries. It should be noted that a robot including the camera (e.g., on which the camera is mounted), in an embodiment, may set its course independently in order to achieve an improved bird's-eye view. The improved bird's-eye view, for example, have better coverage, have higher resolution, or eliminate reflections.

At S140, a scene geometry is determined based on the camera motion and the input images. The scene geometry is a structure of a scene including three-dimensional (3D) coordinates corresponding to two-dimensional (2D) image coordinates of the image patches. In an embodiment, S140 includes computing the scene geometry using triangulation.

At optional S150, a scale factor is determined based on the scene geometry and one or more scene parameters related to the scene. The scene parameters may include, but are not limited to, predetermined sizes of objects in the scene (e.g., a known size of an object in the scene), motion parameters related to movement of the device that captured the input images within the scene (e.g., movements of wheels, accelerometer data), a configuration of the camera used to capture the input images (e.g., a configuration of a stereo camera), and the like. The scale factor is a value used in order to adjust scale estimation when determining camera motion and scene geometry.

At optional S160, the input images may be stitched in preparation of creating the synthesized image. The image stitching may utilize, for example, the rectilinear model of image stitching. In an embodiment, the stitching may be performed based on the camera motion. It is noted that, since both the camera motion and the scene geometry are known, the alignment of each image is also known with respect to at least one camera parameter (e.g., location, orientation, internal calibration, etc.). Thus, the stitching may be performed based on this known alignment.

During the rectification process, the input images are resampled and, therefore, may have non-uniform effective resolutions. To this end, the image stitching includes blending the input images. During the blending, images having higher effective resolutions may be given higher weight than images having lower effective resolutions.

Alternatively to stitching, preparation for creating the synthesized image may include performing image-based modeling and rendering on the input images. In such an embodiment, a 3D model resulting from the image-based modeling and rendering is utilized for creation of the synthesized image.

At S170, a synthesized image is created. The synthesized image is a projection showing a single perspective of the scene for all of the input images. In an example implementation, the synthesized image is an orthographic projection showing a bird's-eye view image. The synthesized image is created by performing image rectification on the input images based on the scene geometry and relative positions of the camera when capturing the input images. In an embodiment, the synthesized image is created based further on the scale factor. In another embodiment, the synthesized image is created based further on the stitched image.

At S180, changes in the synthesized image are determined. The changes may be determined based on, for example, change detection, image differencing, image regression, or change vector analysis performed on the stitched image. In an embodiment, S180 further includes determining anomalies in the synthesized image. The anomalies may be determined in the synthesized image by computing a statistical distribution of image patches and identifying image patches that do not belong to a discrete probability distribution. The discrete probability distribution is a subset of the statistical distribution that may be defined, for example, by upper and lower limits. The upper and lower limits may, in turn, be defined based on, for example, percentiles.

In some embodiments, S180 may further include generating an alert when a change, an anomaly, or both, has been determined. The alert may be sent to, for example, a user device or robot control system to allow for responding to the change or anomaly.

At S190, the synthesized image is sent or stored for subsequent use. The subsequent use may be related to one or more robotics applications such as, but is not limited to, navigation, cleaning, graphical user interface controls, and the like. To this end, S190 may include generating a graphical user interface incorporating the single perspective synthesized image and sending the graphical user interface for display on, for example, a user device. The graphical user interface may allow, for example, the user to control the robot with respect to objects shown in the synthesized image.

In an embodiment, S190 may further include storing the determined changes or anomalies for subsequent use. The determined changes or anomalies may be incorporated into one or more other robotics functions to allow for additional uses of the changes or anomalies. As a non-limiting example, a cleaning robot may be configured to identify any changes as potentially being dirt for cleaning and, upon identifying such dirt, may be configured to clean the location at which the change was identified.

When a user is provided with a user interface allowing for interactions with the robot in order to provide inputs related to controlling the motion of the robot (e.g., directing navigation, marking forbidden areas to which the robot should not move, etc.), alerts may be generated and displayed to the user when anomalies are determined. Since the synthesized image is a projection of a 3D model, 3D coordinates of the selected area may be determined based on the interactions with the user interface.

As a non-limiting example for use of a user interface, for a lawncare robot, the lawncare robot may capture images used to generate synthesized images as it moves through a garden. Any or all of the synthesized images may be sent to a user device for display as part of a graphical user interface (GUI). The user device receives user inputs via the GUI in the form of selections of areas shown in the synthesized images. The user inputs may further indicate whether each selected area is an allowed area or a forbidden area. The allowed area is an area which the user acknowledges is an acceptable area for the robot to move to, to perform functions (e.g., cleaning) at, or both. The forbidden area is an area which the user forbids the robot to move to, to perform functions (e.g., cleaning) at, or both. Using allowed and forbidden areas allows the user to control access of the robot to potentially sensitive locations. As a non-limiting example, a user may allow the robot to perform lawncare functions only within their yard. As another-non-limiting example, a user may forbid the robot from cleaning in an area where small items (e.g., toys) are on the ground.

Synthesized images showing views before and after determined changes may be retained and viewed by a user to allow for comparisons among synthesized images such as, for example, to search for objects in the area that may have moved. As a non-limiting example, a first synthesized image generated based on input images captured between a first 30 second time period may be compared to a second synthesized image generated based on input images captured between the preceding 30 second time period (i.e., the 30 seconds before the start of the first 30 second time period) and to a third synthesized image generated based on input images captured between the subsequent 30 second time period (i.e., the 30 seconds after the end of the first 30 second time period). The compared images may be included a comparative display.

In an embodiment, S190 may further include performing one or more actions based on the synthesized image. In a further embodiment, the actions include modifying movement of a robot or robotic device. As non-limiting examples, aspects of movement that may be modified may include, but are not limited to, direction, speed, acceleration, altitude, navigation path, and the like.

The movement of the robot or robotic device may be modified in order to address changes determined at S180. To this end, in a further embodiment, S190 includes detecting one or more objects based on the synthesized image. The objects may be detected using a machine learning model trained based on training synthesized images and known objects. Based on the detected objects, a change in navigation may be determined (i.e., to avoid obstacles). To this end, S190 may further include utilizing an object detection and recognition model trained by machine learning of historical image data. In an example implementation, the model is a convolutional neural network.

The detected objects may be utilized, for example, in determining how to modify movement. To this end, the locations of the detected objects may be identified as areas of interest to which the robot should move. As a non-limiting example, if a detected object is a spec of dust, the movement of a cleaning robot may be modified such that the cleaning robot moves to the dust. As another non-limiting example, if a detected object is an unhealth lawn area (e.g., a portion of a lawn having excessively long grass or having weeds), the movement of a lawncare robot may be modified such that the lawncare robot moves to the unhealthy lawn area. As yet another non-limiting example, if a detected object is a box, the movement of a logistics robot used for warehouse applications may be modified such that the logistics robot moves to the box (e.g., in order to retrieve or otherwise move the box).

Alternatively or collectively, an alert may be generated and sent (e.g., to a user device) indicating the location of a detected object. As a non-limiting example, if the detected object is identified as a mobile phone or a key, an alert indicating the location of the detected mobile phone or key may be sent to a user device.

In a further embodiment, S190 may further include storing detected changes or anomalies. In yet a further embodiment, S190 may further include causing a robot to perform one or more actions based on the changes or anomalies. The actions may include, but are not limited to, modifying motion by the robot, activating one or more functions (e.g., cleaning functions, camera functions, delivery functions such as dropping items, etc.). As a non-limiting example, a cleaning robot may be caused to move to and clean an area when a change in the area has been detected.

FIG. 2 is an example schematic diagram of an image synthesizer 200 according to an embodiment. The image synthesizer 200 includes a processing circuitry 210 coupled to a memory 220, a storage 230, and sensors 240. The components of the image synthesizer 200 may be communicatively connected via a bus 250. In an embodiment, the image synthesizer 200 may be included in or communicatively connected to a system for controlling a robot configured for movement (not shown). Specifically, synthesized images created by the image synthesizer may be used for, for example, navigation of the robot, obstacle detection and avoidance, and the like. In some implementations, the image synthesizer 200 may include an illuminator controller configured to control a source of illumination such as, but not limited to, a light emitting diode (LED).

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In an embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, configure the processing circuitry 210 to perform the various processes described herein.

The storage 230 may be magnetic storage, optical storage, and the like, and may be realized, for example, as flash memory or other memory technology, CD-ROM, Digital Versatile Disks (DVDs), or any other medium which can be used to store the desired information.

The sensors 240 include at least image capturing sensors. For example, the sensors 240 may include an image sensor such as, but not limited to, a camera including a wide-angle lens. The wide-angle lens may be, for example, a fisheye lens. The sensors may further include movement-based sensors such as, but not limited to, gyroscopes, accelerometers, magnetometers, and the like. In an example implementation, the movement-based sensors may be included in an inertial measurement unit (IMU). The movement-based sensors may be deployed on or in a robot configured for movement such that the movement-based sensors can be utilized to track movements of the robot.

It should be understood that the embodiments described herein are not limited to the specific architecture illustrated in FIG. 2, and other architectures may be equally used without departing from the scope of the disclosed embodiments. In an example implementation, the image synthesizer 200 may be incorporated into a system for controlling a robot (not shown). The system incorporating the image synthesizer 200 may further include other units such as, but not limited to, control unit, object recognition unit, artificial intelligence unit, communication unit, and the like.

In an example implementation, the sensors of FIG. 2 may be included in a camera module configured such as a camera module 310 shown in FIG. 3. In the example schematic diagram 300 of FIG. 3, the camera module 310 includes an image sensor 312 and an inertial measurement unit (IMU) 314. The camera module 310 is connected to a flexible printed circuit (FPC) 320. The camera module 310 may be mounted to a robot using, for example, mounting holes 316. The IMU 314 may be disposed as close as possible to the image sensor 312, and may be mounted on a ridged printed circuit board (PCB, not shown). A connector 330 may be disposed on the FPC 320 on the back side. In an example implementation, the width of the module 310 is less than 15 millimeters (mm) and the z-height of the module is less than 10 mm.

FIGS. 4A and 4B are example views 400A and 400B, respectively, of a stitched image. The stitched image may be created as described herein above with respect to FIG. 1. The view 400B further shows outlines of various image patches 410-1 through 410-5. The image patches 410-1 through 410-5 are partially overlapping sub-regions shown in different input images. For any two of the image patches 410-1 through 410-5, there is a sequence of pairs of partially overlapping image patches 410 between them. For example, for the image patches 410-1 through 410-5, pairs of image patches 410-1 and 410-2, 410-2 and 410-3, 410-3 and 410-4, and 410-4 and 410-5, collectively stretch from image patch 410-1 to image patch 410-5.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for controlling a robotic device in motion using image synthesis, comprising:
determining a plurality of local motion features based on a plurality of image patches included in a plurality of input images captured by a camera installed on the robotic device, the plurality of input images including a first input image and a second input image;
determining a camera motion based on the plurality of local motion features, wherein the camera motion indicates a movement of the camera between capture of the first input image and capture of the second input image;
determining a scene geometry based on the camera motion, wherein the scene geometry is a set of three-dimensional coordinates corresponding to two-dimensional image coordinates of the plurality of image patches;
generating a synthesized image based on the camera motion and the scene geometry, wherein the synthesized image is a single perspective image;
detecting at least one change between the first input image and the second input image based on the synthesized image; and
modifying movement of the robotic device based on the detected at least one change.

2. The method of claim 1, wherein the plurality of local motion features at least describes a transformation between a first image patch and at least one second image patch, wherein the first image patch is included in the first input image, wherein the at least one second image patch is included in the second input image.

3. The method of claim 1, further comprising:
determining at least one outlier local motion feature of the plurality of local motion features, wherein the plurality of local motion features includes the at least one outlier local motion feature and at least one other local motion feature, wherein the camera motion is determined based on the at least one other local motion feature.

4. The method of claim 1, further comprising:
determining a scale factor based on the scene geometry, wherein the synthesized image is generated based further on the scale factor.

5. The method of claim 1 further comprising:
stitching the first input image and the second input image in order to create a stitched image, wherein the synthesized image is generated based further on the stitched image.

6. The method of claim 5, wherein the stitching is based on the camera motion.

7. The method of claim 1, further comprising:
detecting at least one anomaly in the synthesized image, wherein detecting the at least one anomaly further comprises computing a statistical distribution of the plurality of image patches and identifying at least one image patch that does not belong to a discrete probability distribution of the statistical distribution.

8. The method of claim 1, further comprising:
generating a user interface based on the synthesized image, wherein the user interface includes an interactive display of the synthesized image, wherein at least one user input related to controlling the movement of the robotic device is received via the user interface.

9. The method of claim 8, wherein the interactive display further includes a comparative display of the generated synthesized image and at least one other synthesized image.

10. The method of claim 8, wherein the robotic device is configured to perform at least one lawncare function, further comprising:
determining, based on the at least one user input, at least one forbidden area, wherein the robotic device does not perform the at least one lawncare function in the at least one forbidden area.

11. The method of claim 1, wherein the movement of the robotic device is on a ground surface.

12. The method of claim 1, wherein the detected at least one change is identified as showing an area of interest, wherein the movement of the robotic device is modified such that the robotic device moves to the area of interest.

13. The method of claim 12, wherein the at least one area of interest is any of: a portion of a floor requiring cleaning, and a portion of a lawn requiring mowing.

14. A non-transitory computer readable medium having stored thereon instructions for causing a processing circuitry to execute a process, the process comprising:
determining a plurality of local motion features based on a plurality of image patches included in a plurality of input images captured by a camera installed on the robotic device, the plurality of input images including a first input image and a second input image;
determining a camera motion based on the plurality of local motion features, wherein the camera motion indicates a movement of the camera between capture of the first input image and capture of the second input image;
determining a scene geometry based on the camera motion, wherein the scene geometry is a set of three-dimensional coordinates corresponding to two-dimensional image coordinates of the plurality of image patches;
generating a synthesized image based on the camera motion and the scene geometry, wherein the synthesized image is a single perspective image;
detecting at least one change between the first input image and the second input image based on the synthesized image; and
modifying movement of a robotic device based on the detected at least one change.

15. A system for controlling a robotic device in motion using image synthesis, comprising:
a processing circuitry; and
a memory, the memory containing instructions that, when executed by the processing circuitry, configure the system to:
determine a plurality of local motion features based on a plurality of image patches included in a plurality of input images captured by a camera installed on the robotic device, the plurality of input images including a first input image and a second input image;
determine a camera motion based on the plurality of local motion features, wherein the camera motion indicates a movement of the camera between capture of the first input image and capture of the second input image;
determine a scene geometry based on the camera motion, wherein the scene geometry is a set of three-dimensional coordinates corresponding to two-dimensional image coordinates of the plurality of image patches;
generate a synthesized image based on the camera motion and the scene geometry, wherein the synthesized image is a single perspective image;
detect at least one change between the first input image and the second input image based on the synthesized image; and
modify movement of the robotic device based on the detected at least one change.

16. The system of claim 15, wherein the plurality of local motion features at least describes a transformation between a first image patch and at least one second image patch, wherein the first image patch is included in the first input image, wherein the at least one second image patch is included in the second input image.

17. The system of claim 15, wherein the system is further configured to:
determine at least one outlier local motion feature of the plurality of local motion features, wherein the plurality of local motion features includes the at least one outlier local motion feature and at least one other local motion feature, wherein the camera motion is determined based on the at least one other local motion feature.

18. The system of claim 15, wherein the system is further configured to:
determining a scale factor based on the scene geometry, wherein the synthesized image is generated based further on the scale factor.

19. The system of claim 15, wherein the system is further configured to:
stitch the first input image and the second input image in order to create a stitched image, wherein the synthesized image is generated based further on the stitched image.

20. The system of claim 19, wherein the stitching is based on the camera motion.

21. The system of claim 15, wherein the system is further configured to:
detect at least one anomaly in the synthesized image, wherein detecting the at least one anomaly further comprises computing a statistical distribution of the plurality of image patches and identifying at least one image patch that does not belong to a discrete probability distribution of the statistical distribution.

22. The system of claim 15, wherein the system is further configured to:
generate a user interface based on the synthesized image, wherein the user interface includes an interactive display of the synthesized image, wherein at least one user input related to controlling the movement of the robotic device is received via the user interface.

23. The system of claim 22, wherein the interactive display further includes a comparative display of the generated synthesized image and at least one other synthesized image.

24. The system of claim 22, wherein the robotic device is configured to perform at least one lawncare function, wherein the system is further configured to:
determine, based on the at least one user input, at least one forbidden area, wherein the robotic device does not perform the at least one lawncare function in the at least one forbidden area.

25. The system of claim 15, wherein the movement of the robotic device is on a ground surface.

26. The system of claim 15, wherein the detected at least one change is identified as showing an area of interest, wherein the movement of the robotic device is modified such that the robotic device moves to the area of interest.

27. The system of claim 26, wherein the at least one area of interest is any of: a portion of a floor requiring cleaning, and a portion of a lawn requiring mowing.

28. A robotic device, comprising:
a camera, wherein the camera is configured to capture a plurality of images, the plurality of images including a first image and a second image;
a processing circuitry; and
a memory, the memory containing instructions that, when executed by the processing circuitry, configure the processing circuitry to control movement of the robotic device based on image synthesis, wherein the processing circuitry is further configured to:
determine a plurality of local motion features based on a plurality of image patches included in the plurality of images;
determine a camera motion based on the plurality of local motion features, wherein the camera motion indicates a movement of the camera between capture of the first image and capture of the second image;
determine a scene geometry based on the camera motion, wherein the scene geometry is a set of three-dimensional coordinates corresponding to two-dimensional image coordinates of the plurality of image patches;
generate a synthesized image based on the camera motion and the scene geometry, wherein the synthesized image is a single perspective image;
detect at least one change between the first image and the second image based on the synthesized image; and
modify movement of the robotic device based on the detected at least one change.

29. The robotic device of claim 28, wherein the robotic device is any one of: a robotic lawn mower, a cleaning robot, and a logistics robot.
